(19) United States
(12) Patent Application Publication
(10) Pub. No.: US 2016/0009063 A1
(43) Pub. Date: Jan. 14, 2016

(54) FOAM AND PLASTIC BONDING PROCESS FOR PROTECTIVE INSULATION SYSTEM

(71) Applicant: John Calvino, JR., Coral Springs, FL (US)

(72) Inventor: John Calvino, JR., Coral Springs, FL (US)

(21) Appl. No.: 14/329,204

(22) Filed: Jul. 11, 2014

(51) Int. Cl. B32B 37/06; B32B 37/10; B32B 38/18; B32B 37/02; B32B 37/00; B32B 38/00; B32B 37/18; B32B 37/04

(52) U.S. Cl. CPC B32B 37/06; B32B 37/182; B32B 37/1027; B32B 37/04; B32B 37/02; B32B 37/0046; B32B 38/0008; B32B 38/18; B32B 2305/02; B32B 2307/304; B32B 2310/0825; B32B 2325/00; B32B 2439/00

(57) ABSTRACT

An apparatus for fabricating a composite material by fusing a foam material to a plastic material is provided. The apparatus includes a pressure element and at least one heating element that directly heats the plastic material. The heated plastic material transfers absorbed heat energy to the foam material. The apparatus includes a transport element that transports the heated foam material and the heated plastic material to the pressure element. The pressure element and transport element presses the heated plastic material against the heated foam material. The transport element transports the pressed plastic material and foam material from the pressure element. The plastic material and the foam material fuse together to create the fused composite board. The fusing of the plastic material to the foam material occurring without adding a material different from plastic and foam materials between the plastic element and the foam element to provide the fusing

### FIELD OF THE INVENTION

The present invention provides an apparatus and method for fabricating a composite material by fusing a foam material to a plastic material.

### BACKGROUND OF THE INVENTION

Expanded Polystrene (EPS) foam is in widespread use for various consumer products such as disposable cups and beverage coolers. EPS foam is a thermoplastic, closed-cell, lightweight and rigid-foam plastic. EPS foam is also used as an insulation material as it is a good thermal insulator. EPS foam sheets are also used for building insulation and EPS foam “peanuts” are commonly used as a packing material for fragile items. However, by itself, EPS foam has limited strength and durability as is commonly seen in EPS foam cups and coolers that can be easily broken.

### SUMMARY OF THE INVENTION

The present invention advantageously provides a method and system for fabricating a composite material by fusing a foam material to a plastic material.

According to one embodiment, an apparatus for fabricating a composite material by fusing a foam material to a plastic material is provided. The apparatus includes a pressure element and at least one heating element that directly heats the plastic material. The plastic material is in direct contact with the foam material. The heated plastic material transfers absorbed heat energy to the foam material. The apparatus includes a transport element that transports the heated foam material and the heated plastic material to the pressure element. The pressure element and transport element presses the heated plastic material against the heated foam material. The transport element transports the pressed plastic material and foam material from the pressure element. The plastic material and the foam material fuse together to create the fused composite board. The fusing of the plastic material to the foam material occurs without adding an adhesive between the plastic element and the foam element.

According to one embodiment of this aspect, the at least one heating element includes a plurality of infrared heaters. According to another embodiment of this aspect, the transport element transports the heated foam material and heated plastic material to the pressure element at a speed ranging from fifteen feet per minute to sixty feet per minute. According to another embodiment of this aspect, the heated plastic material transfers absorbed heat energy to the foam material melts a portion of foam material to form a molten layer of the form material that will fuse the plastic material to the foam material. According to another embodiment of this aspect, the molten layer of foam material is a binding agent used to fuse the foam material to the plastic material in which the molten layer of foam material is the only binding agent used to fuse foam material to the plastic material.

According to another embodiment of this aspect, the foam material is an Expanded Polystyrene (EPS) foam material and the plastic element is a Styrene plastic material. According to another embodiment of this aspect, the Styrene plastic material is approximately 0.030 inches thick. According to another embodiment of this aspect, a point at which the pressure element and transport element presses the heated plastic element against the heated foam element is approximately 9.5 inches from the closet at least one heating element. According to another embodiment of this aspect, the temperature range of the at least one heating element is between 180 and 300 degrees Celsius. According to another embodiment of this aspect, the pressure element is a motorized roller and the apparatus further includes a roller heating element configured to heat the motorized roller.

According to another embodiment of the invention, a method for fabricating a composite board by fusing a foam material to a plastic material is provided. The plastic material is heated. The plastic material is in direct contact with the foam material. The heated plastic material transfers absorbed heat energy to the foam material. The heated foam material and the heated plastic material are transferred to a pressure element. The heated plastic material is pressed against the heated foam material. The pressed plastic material and foam material are transported from the pressure element. The plastic material and the foam material are fused together to create the fused composite board. The fusing of the plastic material to the foam material occurs without adding an adhesive between the plastic element and the foam element.

According to another embodiment of this aspect, the heating the plastic material includes directly heating the plastic material with a plurality of infrared heaters. According to another embodiment of this aspect, the transporting of the heated foam material and heated plastic material to the pressure element occurs at a speed ranging from fifteen feet per minute to sixty feet per minute. According to another embodiment of this aspect, the heated plastic material transfers absorbed heat energy to the foam material melts a portion of foam material to form a molten layer of the form material that will fuse the plastic material to the foam material.

According to another embodiment of this aspect, the molten layer of foam material is a binding agent used to fuse the foam material to the plastic material in which the molten layer of foam material is the only binding agent used to fuse foam material to the plastic material. According to another embodiment of this aspect, the foam material is an Expanded Polystyrene (EPS) foam material and the plastic element is a Styrene plastic material. According to another embodiment of this aspect, the Styrene plastic material is approximately 0.030 inches thick. According to another embodiment of this aspect, a location at which the pressure element and transport element presses the heated plastic element against the heated foam element is approximately 9.5 inches from the closet at least one heating element. According to another embodiment of this aspect, the temperature range of the at least one heating element is between 180 and 300 degrees Celsius.

According to another embodiment of the invention, an apparatus for fabricating a composite material by fusing an Expanded Polystyrene (EPS) foam material to a Styrene plastic material is provided. The apparatus includes a motorized roller and a plurality of infrared heaters directly heating the Styrene plastic material. The Styrene plastic material is in direct contact with the EPS foam material. The heated Styrene plastic material transfers absorbed heat energy to the EPS foam material to form a molten layer of the EPS form material that will fuse the Styrene plastic material to the EPS foam material. The apparatus includes a conveyor transporting the heated EPS foam material and the heated Styrene plastic material to the motorized roller. The apparatus includes the motorized roller and conveyor pressing the heated Styrene plastic material against the heated EPS foam material. The conveyor transports the pressed Styrene plastic material and EPS foam material from the motorized roller to a cooling area of the conveyor. The Styrene plastic material and the EPS foam material fuse together to create the fused composite board while in the cooling area. The molten layer of foam material is the only binding agent used to fuse the EPS foam material to the Styrene plastic material.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a view of an exemplary foam and plastic bonding apparatus for fabricating a composite material in accordance with the principles of the present invention;

FIGS. 2A-2E are sides views of a portion of the apparatus of FIG. 1 during fabrication of the composite material in accordance with the principles of the present invention;

FIG. 3 is a flow chart of an exemplary foam and plastic bonding process in accordance with the principles of the present invention;

FIG. 4 is a view of an embossed composite material; and

FIG. 5 is a view of an alternate embossed composite material.

### DETAILED DESCRIPTION OF THE INVENTION

The present invention advantageously provides a system, apparatus and method for fabricating a composite material by fusing a foam material to a plastic material. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

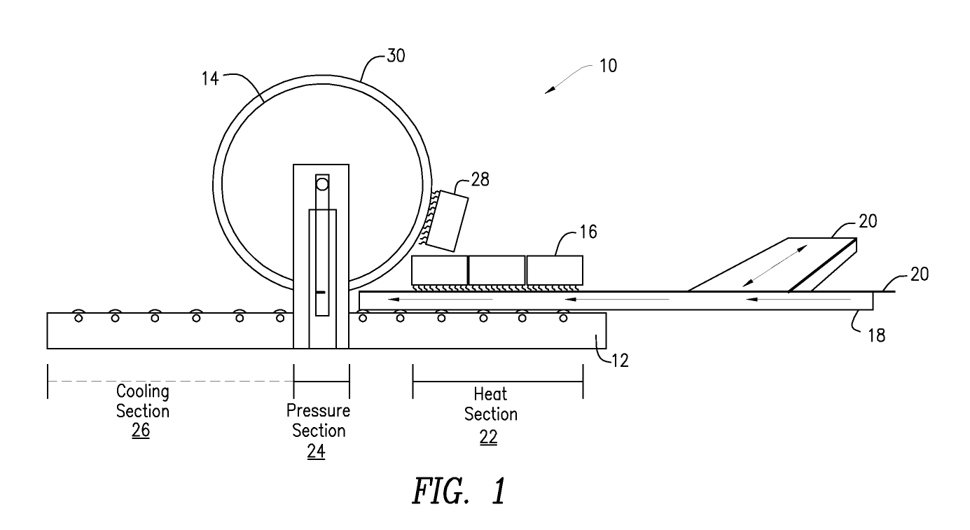

Referring now to drawing figures in which like reference designators refer to like elements there is shown in FIG. 1 an exemplary system for fabricating a composite material by fusing a foam material to a plastic material in accordance with the principles of the present invention and designated generally as “10.” System 10 includes transport element 12, pressure element 14 and one or more heating elements 16 (heating element 16). Transport element 12 is configured to transport foam material 18 and plastic material 20 through various process section including heat section 22, pressure section 24 and cooling section 26. In one embodiment, cooling section 26 may be omitted. Transport element 12 may be a conveyor with rollers and/or a belt, other type of conveyor or other mechanism capable of transporting materials 18 and 20 to one or more of sections 22, 24 and 26. In one embodiment, transport element 12 is configured to transport materials 18 and 20 at a speed ranging between 15 feet per minute to 60 feet per minute. Other speeds of operation of transport element 12 may be implemented in which higher speeds require higher temperatures in heating section 22.

Heating element 16 is configured to directly heat one side of plastic material 20 such as to indirectly heat foam material 18. In one embodiment, heating element 16 provides heat ranging from approximately 180 to 300 degrees Celsius. Heating element 16 may be one or more infrared heaters or ceramic infrared heaters, among one or more other types of heating elements. Heating element 16 advantageously directly heats plastic material 20 to a specific temperature range in which plastic material 20 then heats foam material 18 to a specific temperature range such as to create a molten layer of foam material 18 discussed below. In one embodiment, plastic material 20 is heated to a temperature ranging from 240-360 degrees Fahrenheit. In one embodiment, foam material is heated to a temperature ranging from 160-180 degrees Fahrenheit.

In one embodiment, the nearest heating element 16 to pressure element 14 is positioned approximately 9.5 inches from a pressure location where pressure element 14 provides a maximum pressing force on plastic material 20. In one embodiment, an additional heating element 28 such as roller heating element may be positioned to directly heat pressure element 14. While the multiple heating elements 16 are illustrated in FIG. 1 as being on the same plane and substantially parallel to transport element 12, other configurations of the one or more heating elements 16 relative to transport element 12 may be used where these configuration(s) provide heat to plastic material 20 as described herein.

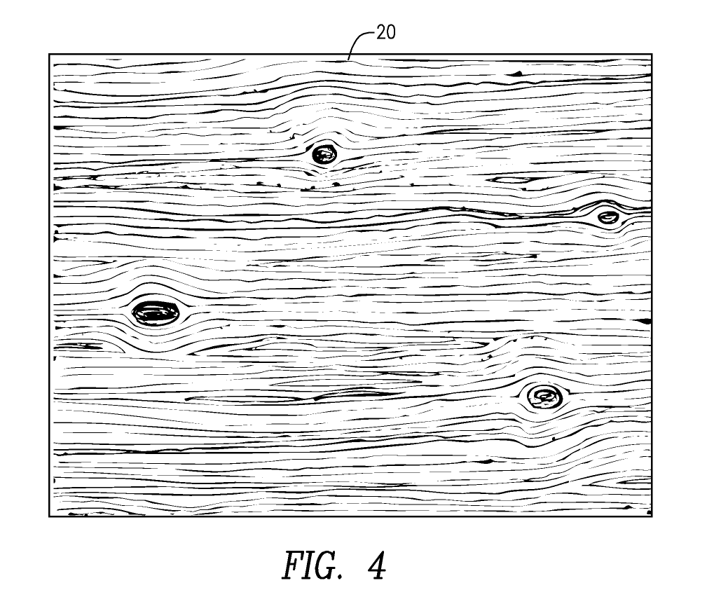

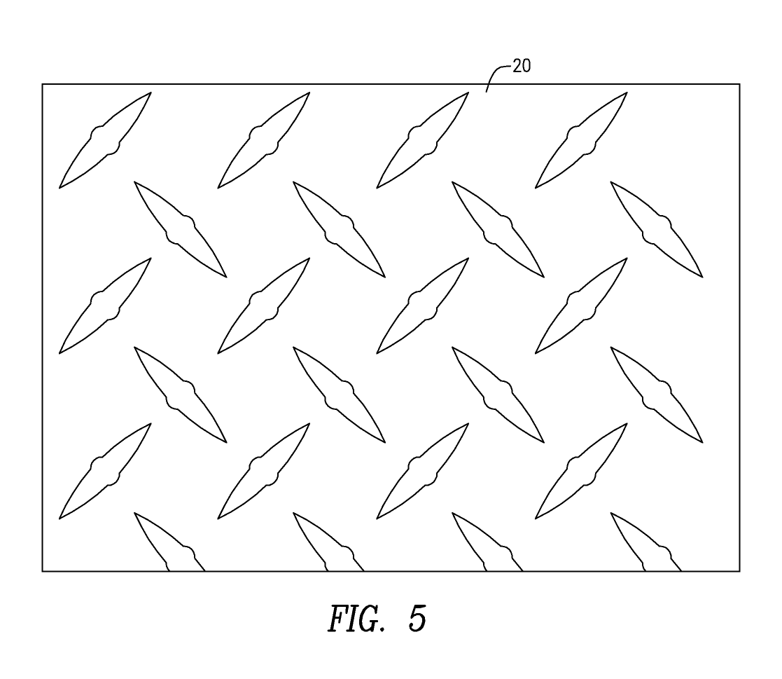

Pressure element 14 is configured to work in combination with transport element 12 to apply a force to plastic element 20 to press plastic element 20 against foam element 18 that is disposed on transport element 12. For example, pressure element 14 presses down against one side of plastic element 20 while the other side of plastic element 20 is disposed on foam element 18. Pressure element may be a roller, motorized roller, one or more pressing plates, among other mechanisms known in the art for applying pressure to an object. Pressure element 14 may be fixed with respect to transport element 12. Pressure element 14 and transport element 12 provide pressure section 24 where heated plastic material 20 is pressed against heated foam material 18. Further, pressure element 14 may include one or more embossed surfaces 30 (embossed surface 30) that are configured to transfer a predefined design on to the side of plastic material 20 that is facing pressure element 14. Embossed surface 30 advantageously molds plastic material 20 to one or more predefined structures such as a wood grain structure or other pattern, as illustrated in FIGS. 4 and 5.

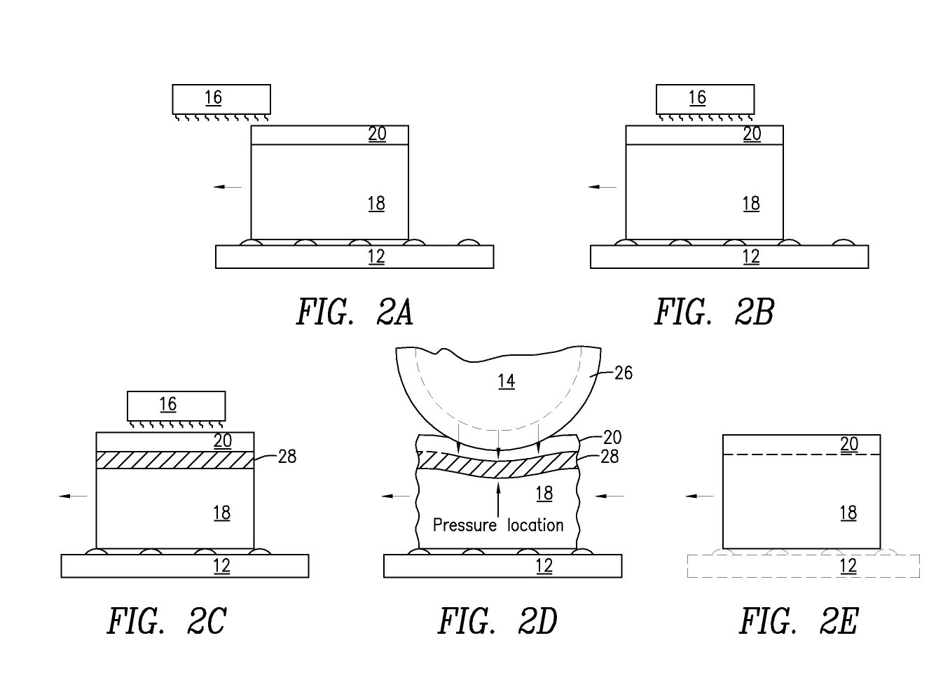

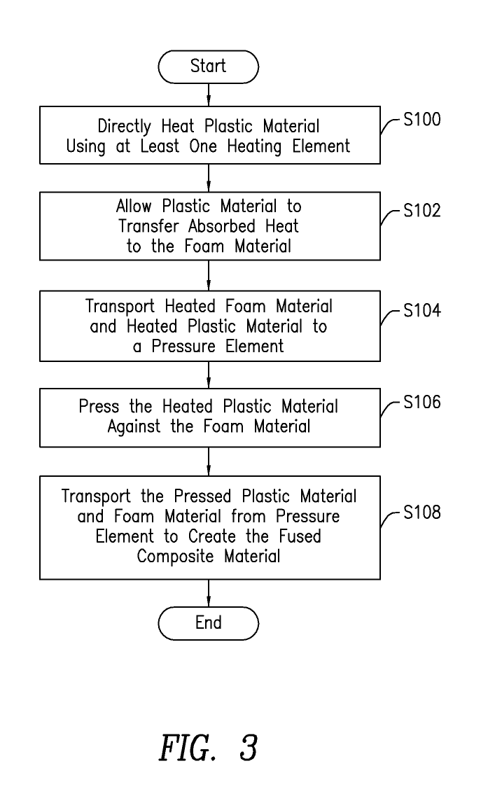

Foam material 18 may be a foam board such as an Expanded Polystyrene (EPS) foam board, among other foamed and/or non-foamed material that can be heated to a molten or melted state such that the molten portion of the foam material acts as an adhesive for fusing the foamed material to another material, as discussed in detail with respect to FIGS. 2-3. The portion of the foam material forming the molten layer may be heated to a viscous state. In one embodiment, foam material 18 has a width of approximately twenty-one inches. Various sized foam materials 18 having different width, thickness and/or length may also be used in accordance with the principles of the present invention.

Plastic material 20 may be a styrene plastic such as a high impact styrene plastic or other plastic material that is able to transfer heat to foam material 18 and be fused with foam material 18 by using a molten layer of foam material 18 as the fusing agent, i.e., no other chemical or material is added to foam material 18 and plastic material 20 to create the bond. In one embodiment, plastic material 20 may be shaped as a plastic sheet having a thickness of approximately 0.030 inches. Plastic material 20 may have a length and width substantially corresponding to the length of width of foam material 18, although plastic material may be of greater or lesser width, thickness and/or length than foam material 18.

System 10 may include cooling section 26 that is located after pressing section 24. For example, cooling section 26 may be located after plastic material 20 and foam material have been pressed together and fused. Cooling section 26 may be a temperature controlled section or any environment that reduces the temperature of the pressed plastic and foam materials. Cooling section 26 assist materials 18 and 20 to maintain strength and to prevent air shock which can cause the curling or bowing effect on the newly formed sheet. For example, cooling section 26 allows the composite board to cure slowly. Therefore, transport element 12 advantageously transports plastic material 20 and foam material 18 from heat section 22 to pressing section 24 to initiate the fusing of plastic material 20 to foam material 18, and then to cooling section 26 that keeps the fabricated composite material including plastic material 20 from curling or bowing. The speed at which foam material 18 and plastic material 20 are transported by transporting element 12 through heat section 22, pressure section 24 and/or cooling section 26 may be substantially constant. In an alternative embodiment, the speed at which foam material 18 and plastic material 20 are transported by transporting element 12 may vary.

FIGS. 2A-2E illustrate a side view of a portion of system 10 for fabricating a composite material or board by fusing foam material 18 to plastic material 20. FIG. 2A illustrates plastic material 20 overlaid on or placed on top of foam material 18, both of which are positioned on transport element 12 for transport toward heating element 16. One side of plastic material 20 is in direct contact with one side of foam material 18. Transport element 12 is configured to transport both plastic material 20 and foam material 18 toward heating element 16.

FIG. 2B illustrates plastic material 20 and foam material 18 being transported proximate heating element 16, i.e., plastic material 20 and foam material 18 are transported to a heating section 22. In particular, plastic material 20 and foam material 18 may be positioned in between transport element 12 and heating element 16 such that 1) heating element 16 directly heats plastic material 20 to cause plastic material 20 to enter a relaxed state and flatten on surface of foam material 18; and 2) heating element 16 indirectly heats foam material 18 to create molten layer 28 of foam material 18, as illustrated in FIG. 2C. The temperature of the surface of plastic material 20 that is facing heating element 16 may be different from the temperature of the underside of the surface (opposite side of plastic material 20 than side facing heating element) of plastic material 20 that is in contact with foam material 18. For example, heated plastic material 20 creates molten layer 28 by heating the side of foam material 18 in contact with heated plastic material 20 such that molten layer 28 of foam material 18 acts as an adhesive to fuse foam material 18 to plastic cover 20. While molten layer 28 is illustrated as having uniform thickness, molten layer 28 be unevenly distributed along foam material 18. Molten layer 28 is advantageously configured to be fusing agent or “adhesive” used to fuse plastic material 20 to foam material 18 such that no other chemicals and materials are added to plastic material 20 and foam material 18 to create the bond between these materials. The fusing of plastic material 20 and foam material 20 advantageously creates a stronger and more durable material without the use of added adhesives, thereby reducing manufacturing cost while increasing the speed at which manufacturing board can be manufactured.

FIG. 2D illustrates pressure element 14 pressing plastic element 20 against molten layer 28 of foam material 18. Pressure location indicates a position where maximum pressure is applied by pressure element 14 to plastic material 20 and foam material 18, in accordance with roller embodiment of pressure element 14. In the embodiment illustrated in FIG. 2D, roller 14 presses plastic material 20 against molten layer 28 of foam material 18 as these materials are transported through pressure section 24. FIG. 2E illustrates foam material 18 and plastic material 20 fused together such as to create a composite board. Fusing of plastic material 20 to foam material 18 occurs immediately after pressure from pressure element 14 is removed from the composite board. In one embodiment, fusing of plastic material 20 to foam material 18 occurs immediately after the composite board leaves pressure section 24. Cooling section 26 then allows the composite board to cure slowly. In other words, the permanent bond between foam material and plastic material 20 is formed when the molten layer of the foam material 18 solidifies such that no adhesives need to be added to foam material 18 and plastic material 20 to create the bond between these two materials. As illustrated in FIG. 2E, plastic material 20 and foam material 18 are fused together due to molten layer 28 solidifying or being reduced in temperature.

FIG. 3 illustrates an exemplary process for fabricating a composite board or material by fusing foam material 18 to plastic material 20 using a molten layer of foam material 18 as the binding agent, binder or adhesive, i.e., no other chemicals and/or materials are added to foam material 18 and plastic material 20 to bond these two materials together. Plastic material 20 is directly heated using at least one heating element (Block S100). Plastic material 20 is allowed or configured to transfer absorbed heat to foam material 20 (Block S102). Heated foam material 18 (including molten layer 28) and heated plastic material 20 are transported by transport element 12 to pressure element 14 (Block S104). Heated plastic material 20 is pressed against foam material 18, i.e., against molten layer 28 of foam material 18 (Block S106). Pressed plastic material 20 and foam material 18 are transported to cooling section 26 to allow the composite board to cure slowly (Block S108). Upon removal of pressure from pressure element 14 or upon existing of pressure section 24, plastic material 20 is fused to foam material 18. In one embodiment, plastic material 20 and foam material 18 are fused or bonded to each other immediately pressure from pressure element 14 is removed. The resultant composite material or board advantageously provides a stronger and more durable product without the use of added adhesives.

FIG. 4 illustrates one embodiment in which embossed surface 30 is configured to mold plastic material 20 to a wood grain pattern. FIG. 5 illustrates another embodiment in which embossed surface 30 is configured mold plastic material 20 to a diamond plate pattern. Embossed surface 30 may be configured mold plastic material 20 to one or more patterns such as a brick pattern, stone pattern, logo(s), character(s), etc. Therefore, the instant invention's fabrication process for fabricating a composite material by fusing foam material 18 to plastic material 20 advantageously provides a fabrication process that does not use added adhesives, yet is still able to fuse plastic material 20 to foam material 18 to create a composite material that is durable, strong and has a permanent bond. The fusing agent for bonding plastic material 20 to foaming material 18 is the foam material 18 itself, i.e., molten layer 28 of foam material 18. The composite material has numerous applications such as garage door insulation, insulated roofing systems, insulated wall systems, decorative interior/exterior wall panels, temporary/permanent protection for boat decks, temporary/permanent protection for flooring in the housing industry, boats made from one piece molded forms, surfboards, kayaks, pool floats, decorative floating shapes, gym flooring, coolers and floating docks, among other applications.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An apparatus for fabricating a composite board by fusing a foam material to a plastic material, the apparatus comprising:
a pressure element;
at least one heating element directly heating the plastic material, the plastic material being in direct contact with the foam material, the heated plastic material transferring absorbed heat energy to the foam material;
a transport element transporting the heated foam material and the heated plastic material to the pressure element;
the pressure element and transport element pressing the heated plastic material against the heated foam material; and
the transport element transporting the pressed plastic material and foam material from the pressure element, the plastic material and the foam material fusing together to create the fused composite board, the fusing of the plastic material to the foam material occurring without adding a material different from plastic and foam materials between the plastic element and the foam element to provide the fusing.

2. The apparatus of claim 1, wherein the at least one heating element includes a plurality of infrared heaters.

3. The apparatus of claim 1, wherein the transport element transports the heated foam material and heated plastic material to the pressure element at a speed ranging from fifteen feet per minute to sixty feet per minute.

4. The apparatus of claim 1, wherein the heated plastic material transferring absorbed heat energy to the foam material melts a portion of foam material to form a molten layer of the form material that will fuse the plastic material to the foam material.

5. The apparatus of claim 4, wherein the molten layer of foam material is a binding agent used to fuse the foam material to the plastic material, the molten layer of foam material being the only binding agent used to fuse foam material to the plastic material.

6. The apparatus of claim 1, wherein the foam material is an Expanded Polystyrene (EPS) foam material; and
the plastic element is a Styrene plastic material.

7. The apparatus of claim 6, wherein the Styrene plastic material is approximately 0.030 inches thick.

8. The apparatus of claim 1, wherein a point at which the pressure element and transport element presses the heated plastic element against the heated foam element is approximately 9.5 inches from the closet at least one heating element.

9. The apparatus of claim 1, wherein the temperature range of the at least one heating element is between 180 and 300 degrees Celsius.

10. The apparatus of claim 1, wherein the pressure element is a motorized roller; and
the apparatus further includes a roller heating element configured to heat the motorized roller.

11. A method for fabricating a composite board by fusing a foam material to a plastic material, the method comprising:
heating the plastic material, the plastic material being in direct contact with the foam material, the heated plastic material transferring absorbed heat energy to the foam material;
transporting the heated foam material and the heated plastic material to a pressure element;
pressing the heated plastic material against the heated foam material; and
transporting the pressed plastic material and foam material from the pressure element, the plastic material and the foam material fusing together to create the fused composite board, the fusing of the plastic material to the foam material occurring without adding a material different from plastic and foam materials between the plastic element and the foam element to provide the fusing.

12. The method of claim 11, wherein the heating the plastic material includes directly heating the plastic material with a plurality of infrared heaters.

13. The method of claim 11, wherein the transporting of the heated foam material and heated plastic material to the pressure element occurs at a speed ranging from fifteen feet per minute to sixty feet per minute.

14. The method of claim 11, wherein the heated plastic material transferring absorbed heat energy to the foam material melts a portion of foam material to form a molten layer of the form material that will fuse the plastic material to the foam material.

15. The method of claim 11, wherein the molten layer of foam material is a binding agent used to fuse the foam material to the plastic material, the molten layer of foam material being the only binding agent used to fuse foam material to the plastic material.

16. The method of claim 11, wherein the foam material is an Expanded Polystyrene (EPS) foam material; and
the plastic element is a Styrene plastic material.

17. The method of claim 11, wherein the Styrene plastic material is approximately 0.030 inches thick.

18. The method of claim 11, wherein a location at which the pressure element and transport element presses the heated plastic element against the heated foam element is approximately 9.5 inches from the closet at least one heating element.

19. The method of claim 11, wherein the temperature range of the at least one heating element is between 180 and 300 degrees Celsius.

20. An apparatus for fabricating a composite board by fusing an Expanded Polystyrene (EPS) foam material to a Styrene plastic material, the apparatus comprising:
a motorized roller;
a plurality of infrared heaters directly heating the Styrene plastic material, the Styrene plastic material being in direct contact with the EPS foam material, the heated Styrene plastic material transferring absorbed heat energy to the EPS foam material to form a molten layer of the EPS foam material that will fuse the Styrene plastic material to the EPS foam material;
a conveyor transporting the heated EPS foam material and the heated Styrene plastic material to the motorized roller;
the motorized roller and conveyor pressing the heated Styrene plastic material against the heated EPS foam material;
the conveyor transporting the pressed Styrene plastic material and EPS foam material from the motorized roller, the Styrene plastic material and the EPS foam material fusing together to create the fused composite board; and
the molten layer of foam material is the only binding agent used to fuse the EPS foam material to the Styrene plastic material.
